(19) United States
(12) Patent Application Publication
(10) Pub. No.: US 2026/0217602 A1
(43) Pub. Date: Jul. 30, 2026

(54) MECHANOCHEMICAL SYNTHESIS OF HYDRAULICALLY REACTIVE CEMENTS

(71) Applicant: Georgia Tech Research Corporation, Atlanta, GA (US)

(72) Inventors: Carsten Sievers, Atlanta, GA (US); Kimberly Kurtis, Atlanta, GA (US); Van Son Nguyen, Atlanta, GA (US); Elsa Qoku, Atlanta, GA (US)

(21) Appl. No.: 19/402,455

(22) Filed: Nov. 26, 2025

Related U.S. Application Data
(60) Provisional application No. 63/725,908, filed on Nov. 27, 2024.

(51) Int. Cl. C04B 7/34; C04B 7/44

(52) U.S. Cl. CPC C04B 7/34; C04B 7/44

(57) ABSTRACT

The present disclosure provides a method of making hydraulic cement, comprising providing a vessel having a chamber, placing a first reagent comprising calcium oxide and a second reagent comprising silicon dioxide in the chamber, and mechanochemically reacting the first and second reagents by simultaneously applying mechanical grinding forces and heating the chamber above room temperature to form a reaction product comprising nanocrystalline calcium silicate phases. The method enables formation of hydraulically reactive calcium silicate minerals through thermal-assisted mechanical grinding at lower temperatures than conventional cement kiln processes. The chamber contains grinding elements that apply mechanical impact forces while the vessel is heated to temperatures ranging from 100°C to 800°C. The reaction product comprises Ca-O-Si bonds and silicate phases including tricalcium silicate and dicalcium silicate. The combined treatment produces calcium silicate phases in amounts of at least 70% of the total reaction product.

### CROSS-REFERENCE TO RELATED APPLICATIONS

This application claims the benefit of U.S. Provisional Application No. 63/725,908, filed on 27 November 2024, which is incorporated herein by reference in its entirety as if fully set forth below.

### FIELD OF INVENTION

The present disclosure relates to cement production methods, and more particularly to mechanochemical synthesis of hydraulically reactive calcium silicate, calcium aluminate, calcium aluminoferrite, and/or calcium sulfoaluminate minerals via thermal-assisted mechanical grinding at elevated temperatures.

### BACKGROUND

Cement production represents one of the most energy-intensive industrial processes worldwide, contributing approximately 5-6% of global CO₂ emissions. The conventional cement manufacturing process involves calcination of limestone (CaCO₃) to produce lime (CaO), which is then combined with silica-rich materials such as clay, shale, and sand at temperatures reaching up to 1550°C in rotary kilns. During this high-temperature process, the formation of hydraulically reactive calcium silicate phases, including but not limited to tricalcium silicate (C₃S), tricalcium aluminate (C₃S), dicalcium silicate (C₂S), and tetracalcium aluminoferrite (C₄AF), occurs through solid-state reactions between CaO and SiO₂. Similar processes are used to produce other hydraulic cements, including Ye’elemite (C₄A_{3̅}S)

The energy demands of cement production stem from both the endothermic calcination reaction and the high temperatures needed to facilitate the formation of calcium silicate and calcium aluminate phases. The calcination of limestone typically occurs at temperatures between 800-900°C, while the formation of tricalcium silicate, which comprises approximately 60% of Portland cement, generally occurs at temperatures exceeding 1400°C. These elevated temperature requirements result in substantial fuel consumption and associated greenhouse gas emissions from both the calcination process and fuel combustion.

Various approaches have been explored to improve energy efficiency in cement manufacturing, including heat recovery systems, process optimization, and alternative clinker production methods. Heat recovery technologies such as organic Rankine cycles and Kalina cycles have been implemented to capture waste heat from cement production processes. Process control improvements have focused on optimizing operational parameters including gas and electrical power management, energy balance monitoring, and reaction kinetics control.

Mechanochemistry offers an alternative approach for materials synthesis by utilizing mechanical forces to initiate and drive chemical reactions. This field encompasses processes that harness mechanical collisions, grinding, and impact to enable conversion of solid reactants with limited or no solvent involvement. Mechanochemical processes can create intense mixing effects and generate transient active sites or localized temperature increases that facilitate chemical transformations. These techniques have found applications in various areas including biomass processing, polymer degradation, and pharmaceutical synthesis.

In the context of cement science, mechanochemical approaches have demonstrated the potential to synthesize cementitious materials at reduced temperatures compared to conventional methods. Ball milling and high-energy mechanical processing have been shown to facilitate the formation of calcium aluminate and calcium silicate phases through solid-state reactions. However, these mechanochemical processes typically involve extended processing times to achieve moderate yields, which presents challenges for practical implementation.

The integration of thermal activation with mechanical processing represents a potential pathway for enhancing the efficiency of mechanochemical synthesis. Elevated temperatures during mechanical processing can increase solid-state diffusivity and lower activation energy barriers for chemical reactions. This combined approach may enable the formation of hydraulically reactive phases at temperatures substantially lower than those employed in conventional cement kilns while reducing the processing times associated with purely mechanochemical methods. This combined approach may further provide for reduced carbon dioxide production and energy inputs as a result of reacting CaCO₃ at its surface, instead of throughout as in conventional cement manufacturing by calcination.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method of making hydraulic cement is provided. The method comprises providing a vessel having a chamber. The method comprises placing a first reagent comprising calcium oxide and a second reagent comprising silicon dioxide (e.g., aluminosilicate) in the chamber. The method comprises mechanochemically reacting the first and second reagents by simultaneously applying mechanical grinding forces and heating the chamber to a temperature above room temperature to form a reaction product comprising nanocrystalline calcium silicate phases (e.g., calcium aluminates).

According to other aspects of the present disclosure, the method may include one or more of the following features. The first and second reagents may be present in the chamber at a stoichiometric ratio of calcium to silicon of about 1:1 to about 5:1. The chamber may contain one or more grinding elements. The grinding elements may comprise grinding balls. Applying the mechanical grinding forces may comprise generating impact velocities of 1-20 m/s. Mechanochemically reacting the first and second reagents may comprise heating the chamber to a temperature of 100°C to 1000°C. The vessel may further comprise a thermal controller configured to regulate an internal temperature of the chamber during reacting. The reaction product may comprise Ca-O-Si and/or Ca-O-Al bonds. The reaction product may comprise multiple silicate phases present in an amount of at least 70% of the reaction product. The silicate phases may be present in an amount of at least 90% of the reaction product.

According to another aspect of the present disclosure, a method of synthesizing hydraulically reactive calcium silicate minerals is provided. The method comprises loading calcium oxide and silicon dioxide into a milling vessel containing grinding elements. The method comprises sealing the milling vessel. The method comprises applying mechanical impact forces with the grinding elements to the calcium oxide and silicon dioxide. The method comprises simultaneously heating the milling vessel to an elevated temperature above room temperature during the mechanical impact. The method comprises forming calcium silicate phases having Ca-O-Si and/or Ca-O-Al bonds through the combined application of mechanical impact forces and heating.

According to other aspects of the present disclosure, the method may include one or more of the following features. The calcium oxide and silicon dioxide may be present at a stoichiometric ratio of calcium to silicon of 1:1 to 5:1. The stoichiometric ratio of calcium to silicon may be about 3:1. Applying mechanical impact forces with the grinding elements to the calcium oxide and silicon dioxide may comprise operating the milling vessel to generate impact velocities of 1-20 m/s. The mechanical impact forces may be applied for a duration of 5 minutes to 2 days. The milling vessel may be heated to an elevated temperature of 100°C to 1000°C. The milling vessel may further comprise a thermal controller configured to regulate the elevated temperature during the mechanical impact. The calcium silicate phases may comprise tricalcium silicate, dicalcium silicate, or combinations thereof. The calcium silicate phases may be present in an amount of at least 70% of a total reaction product formed by the combined mechanical and thermal treatment. The calcium silicate phases may be present in an amount of at least 90% of the total reaction product.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF FIGURES

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates a schematic diagram of a reactor vessel for mechanochemical synthesis, according to aspects of the present disclosure.

FIG. 2 depicts X-ray diffraction patterns of a calcium oxide/silicon dioxide mixture milled at different temperatures, according to some embodiments.

FIG. 3 depicts a graph showing crystallinity percentage versus environment temperature for milled samples, according to some embodiments.

FIG. 4 depicts differential scanning calorimetry curves for calcium oxide/silicon dioxide mixtures processed under different conditions, according to some embodiments.

FIG. 5 depicts an ATR-FTIR spectrum of a calcium oxide/silicon dioxide mixture milled at different temperatures, according to some embodiments.

FIG. 6 depicts ²⁹Si MAS-NMR spectra of a calcium oxide/silicon dioxide mixture milled at different environment temperatures , according to some embodiments.

FIG. 7 depicts UV-Vis diffuse reflectance spectroscopy spectra for calcium oxide and silicon dioxide mixtures milled at different environment temperatures, according to some embodiments.

FIG. 8 depicts X-ray diffraction patterns for calcium oxide/silicon dioxide mixtures milled at different temperatures and annealed at elevated temperature, according to some embodiments.

FIGS. 9A-B depict scanning electron microscopy images of an unmilled calcium oxide/silicon dioxide mixture, according to some embodiments.

FIGS. 9C-D depict scanning electron microscopy images of a calcium oxide/silicon dioxide mixture milled at room temperature, according to some embodiments.

FIGS. 9E-F depict scanning electron microscopy images of a calcium oxide/silicon dioxide mixture milled at 100C, according to some embodiments.

FIG. 10A depicts heat flow calorimetry data for calcium oxide/silicon dioxide mixtures during the first hour of hydration, according to some embodiments.

FIG. 10B depicts heat flow calorimetry data for calcium oxide/silicon dioxide mixtures up to 47 hours of hydration, according to some embodiments.

FIG. 11 depicts thermogravimetric analysis curves for calcium oxide/silicon dioxide mixtures processed under different conditions, according to some embodiments.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The term "mechanochemical" is used herein to mean a process that utilizes mechanical forces such as grinding, milling, or impact to initiate and drive chemical reactions between solid reactants. Any process described herein as "mechanochemical" involves the application of mechanical energy to facilitate chemical transformations, often in combination with thermal energy, to enable reactions that would otherwise require higher temperatures or longer reaction times. Rather, use of the word mechanochemical is intended to describe processes that harness mechanical collisions and forces to create reactive conditions for solid-state chemical reactions.

Conventional cement production involves high-temperature processing in kilns that operate at temperatures up to approximately 1550°C. These processes consume substantial energy and contribute to carbon dioxide emissions through both fuel combustion and limestone calcination reactions. The mechanochemical synthesis methods described herein may provide alternative approaches for producing hydraulically reactive cement materials through combined mechanical and thermal processing at reduced temperatures and energy inputs.

The mechanochemical synthesis processes may utilize simultaneous application of mechanical grinding forces and controlled heating to facilitate formation of calcium silicate phases and other cementitious materials. In some cases, the mechanical grinding may create transient active sites and enhance solid-state diffusion between reactants, while thermal activation may lower activation energy barriers for chemical reactions. The combination of mechanical and thermal energy may enable formation of hydraulically reactive phases at temperatures substantially lower than those used in conventional cement kilns.

The methods may involve processing calcium-containing and silicon-containing precursor materials in heated milling vessels or reactors. In some cases, the mechanical forces may be applied through grinding elements such as balls or other impact media that create repeated collisions with the reactant materials. The thermal component may be provided through external heating systems that maintain the processing environment at elevated temperatures during mechanical treatment.

The mechanochemical approaches may enable formation of various cementitious phases including calcium silicates, calcium aluminates, and other hydraulically reactive compounds. In some cases, the resulting materials may exhibit cementitious properties similar to those produced through conventional high-temperature kiln processes. The integration of mechanical activation with thermal treatment may provide energy-efficient pathways for cement production while maintaining the hydraulic reactivity needed for construction applications.

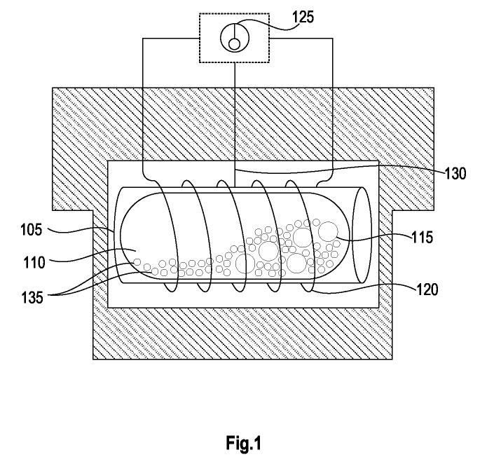

Referring to FIG. 1, a reactor vessel 105 may be configured for mechanochemical synthesis of hydraulically reactive cements. The reactor vessel 105 may include a vessel chamber 110 that contains processed material 135 (i.e., materials resulting from the reaction of multiple reagents) and a plurality of grinding balls 115. In some cases, the vessel chamber 110 may have an internal volume of 25 mL for laboratory-scale operations or much larger volumes in the case of commercial reactors. The grinding balls 115 may be positioned within the vessel chamber 110 to facilitate mechanical grinding of the processed material 135 through impact and friction during operation.

The reactor vessel 105 may be equipped with a heating element 120 that surrounds the exterior of the vessel chamber 110. In some cases, the heating element 120 may provide thermal energy to the vessel chamber 110, enabling elevated temperature processing of the processed material 135. The reactor vessel 105 may be wrapped with a thermal element (e.g., heating tape, wire coil, and the like), secured with aluminum tape. In some cases, three layers of commercial aluminum foil may be wrapped around the outside to prevent damage and heat loss. The reactor vessel 105 may be placed inside a stainless-steel mantle which may be sealed to prevent heat loss.

A thermal controller 125 may be operatively connected to the heating element 120 to regulate the temperature within the vessel chamber 110. In some cases, a thermocouple 130 may extend into or near the vessel chamber 110 to monitor the temperature and provide feedback to the thermal controller 125. The thermal controller 125 may be configured to regulate an internal temperature of the vessel chamber 110 during mechanochemical reacting processes.

The vessel chamber 110 may be sealed a variety of ways, e.g., with a PTFE O-ring, after loading the processed material 135. In some cases, the headspace gas inside the vessel chamber 110 may remain as air during processing. The vessel chamber 110 may be provided with compressed air to prevent overheating during operation.

The grinding balls 115 may comprise various configurations depending on the scale of operation. For laboratory-scale processing, the grinding balls 115 may include ten grinding balls, each 10 mm in diameter and weighing approximately 4.04 g. In some cases, the grinding balls 115 may be made of stainless steel. For industrial-scale operations, the grinding balls 115 may be industrial milling balls that are typically 3 to 4 inches in diameter and a couple of kilograms in mass, similar to a small shot put ball. As would be appreciated by those skilled in the art, the number and size of grinding balls/elements may vary in accordance with various embodiments of the present disclosure.

The reactor vessel 105 may be operated using different milling configurations depending on the processing scale. In some cases, the reactor vessel 105 may be operated using a Retsch MM500 shaker mill for laboratory-scale synthesis. For scaled-up operations, the reactor vessel 105 may be operated as a rotating drum mill instead of a shaker mill. The rotating drum mill configuration may provide an alternative approach for larger-scale mechanochemical processing while maintaining the combined mechanical and thermal treatment capabilities. As those skilled in the are would appreciate, other reactor vessels are also contemplated within the scope of the present disclosure, including, but not limited to, planetary mills, attritor mills, resonant acoustic mixers, and the like.

The mechanochemical synthesis methods may utilize specific reagent compositions and processing parameters to achieve formation of hydraulically reactive cement materials. A first reagent comprising calcium oxide and a second reagent comprising silicon dioxide may be placed in the vessel chamber for processing. In some cases, the calcium oxide may be obtained from clay. In some cases, the calcium oxide may be obtained from reagent grade sources, while the silicon dioxide may comprise quartz sand with particle sizes ranging from 0.5-10μm and purity levels of approximately 99%.

The first and second reagents may be present in the vessel chamber at various stoichiometric ratios of calcium to silicon. In some cases, the stoichiometric ratio of calcium to silicon may range from about 1:1 to about 5:1. The stoichiometric ratio of calcium to silicon may be about 3:1 in certain processing configurations. For example, approximately 0.74 g (0.0132 mol) of calcium oxide and 0.264 g (0.0044 mol) of silicon dioxide may be used to achieve the stoichiometric ratio of calcium to silicon of 3:1. The ranges provided are exemplary in nature and other values and ranges are contemplated within the scope of the present disclosure. Alternative exemplary ranges for the stoichiometric ratio may include 1.5:1 to 4:1, 2:1 to 3.5:1, or 2.5:1 to 3.5:1.

The mechanochemical reacting step may simultaneously apply mechanical grinding forces and heating to facilitate formation of calcium silicate phases. Applying the mechanical grinding forces may comprise operating the vessel at a frequency of 10-30 Hz, though other frequencies are contemplated within the scope of the present disclosure. In some cases, the frequency may be maintained at 20 Hz during processing. The mechanical impact forces may be applied for a duration of 5 minutes to 2 days. The duration ranges provided are exemplary in nature and other values and ranges are contemplated within the scope of the present disclosure. Alternative exemplary duration ranges may include 30 minutes to 24 hours, 1 hour to 12 hours, or 2 hours to 8 hours.

The mechanochemical reacting of the first and second reagents may comprise heating the chamber to a temperature of 100°C to 800°C. In some cases, the milling vessel may be heated to an elevated temperature above room temperature during the mechanical impact. The elevated temperature may range from 100°C to 800°C during processing. The temperature ranges provided are exemplary in nature and other values and ranges are contemplated within the scope of the present disclosure. Alternative exemplary temperature ranges may include 150°C to 600°C, 200°C to 500°C, or 300°C to 700°C.

The vessel chamber may contain different gas phase compositions to create various processing environments. In some cases, the vessel chamber may contain air as the headspace gas during mechanochemical processing. The vessel chamber may contain humidified air instead of regular air to modify the processing conditions. In some cases, the vessel chamber may be operated with an inert gas atmosphere to prevent oxidation or other unwanted side reactions during processing.

The vessel chamber may be operated with concentrated carbon dioxide as a gas during processing to create carbonate phases. In some cases, the concentrated carbon dioxide atmosphere may enable formation of carbonate-containing cementitious materials that may act as carbon sinks. The gas atmosphere composition may be selected based on the desired reaction products and processing objectives. The various gas atmosphere options may provide flexibility in controlling the chemical environment during mechanochemical synthesis.

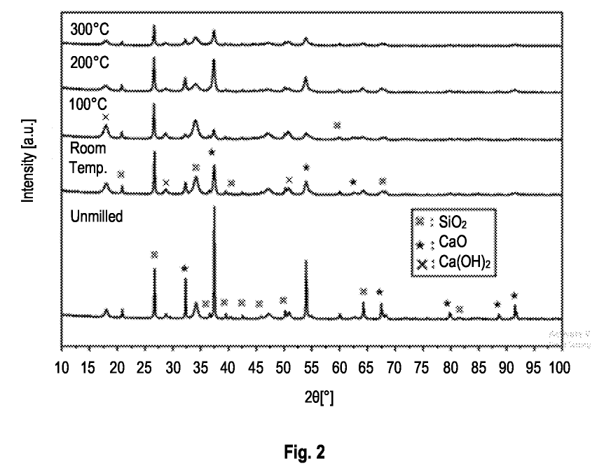

Referring to FIG. 2, X-ray diffraction patterns may be obtained for CaO/SiO₂ mixtures milled at different environment temperatures to characterize the crystallographic changes during mechanochemical processing. The X-ray diffraction patterns may display intensity in arbitrary units on the vertical axis and 2θ in degrees on the horizontal axis, ranging from approximately 10 to 100 degrees. In some cases, five separate diffraction patterns may be shown as stacked traces, representing unmilled material and samples milled at room temperature, 100°C, 200°C, and 300°C.

The diffraction patterns may exhibit multiple diffraction peaks with certain peaks marked by symbols to indicate the presence of specific phases. As shown in FIG. 2, asterisks may denote SiO₂, stars may denote CaO, and X symbols may denote Ca(OH)₂ phases in the processed materials. The unmilled sample may show the most pronounced and sharp diffraction peaks, while the patterns for samples milled at elevated temperatures may display progressively reduced peak intensities and broader features.

The reduction in diffraction intensity with increasing milling temperature may indicate decreased crystallinity and formation of nanocrystalline calcium silicate phases. In some cases, the mechanochemical reacting of the first and second reagents by simultaneously applying mechanical grinding forces and heating the chamber to a temperature above room temperature may form a reaction product comprising nanocrystalline calcium silicate phases. The decrease in diffraction intensity may be attributed to a reduction in crystallinity, suggesting formation of amorphous phases during the mechanochemical processing.

With continued reference to FIG. 2, the diffraction patterns may demonstrate that higher milling environment temperatures may result in greater conversion of the starting crystalline materials to nanocrystalline or amorphous calcium silicate phases. The mechanical grinding forces combined with thermal activation may create conditions that facilitate solid-state reactions between calcium oxide and silicon dioxide. In some cases, the formation of nanocrystalline calcium silicate phases may occur through enhanced solid-state diffusion caused by repeated impacts at moderate temperatures.

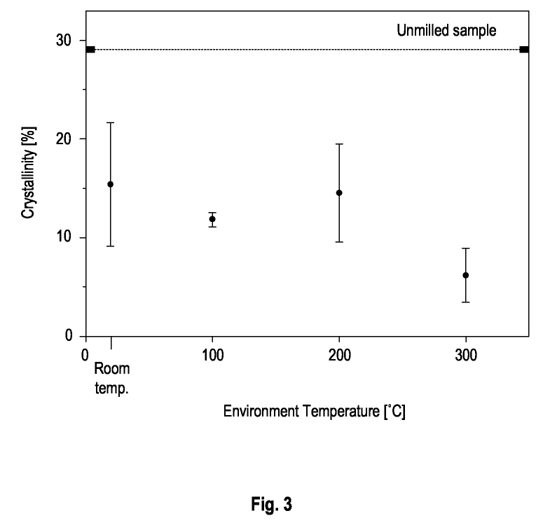

Referring to FIG. 3, a crystallinity analysis may be performed to quantify the degree of crystallinity changes during mechanochemical processing at different temperatures. The graph may show the relationship between crystallinity percentage and environment temperature for unmilled and milled samples. As shown in FIG. 3, the vertical axis may represent crystallinity in percentage, ranging from 0 to approximately 30%, while the horizontal axis may display environment temperature in degrees Celsius.

A horizontal dotted line may indicate the crystallinity level of an unmilled sample at approximately 29%. In some cases, four data points with error bars may be plotted, showing crystallinity values at different milling temperatures. The room temperature processing may show approximately 15% crystallinity, 100°C may show approximately 12% crystallinity, 200°C may show approximately 14% crystallinity, and 300°C may show approximately 6% crystallinity.

The data may demonstrate a general trend of decreasing crystallinity as the milling environment temperature increases, with all milled samples exhibiting lower crystallinity compared to the unmilled sample baseline. In some cases, the reduction in crystallinity may correlate with the formation of nanocrystalline calcium silicate phases through the mechanochemical processing. The crystallinity analysis may provide quantitative evidence that the combined mechanical and thermal treatment facilitates transformation of the starting materials into less crystalline reaction products.

The mechanochemical processing may result in formation of reaction products comprising Ca-O-Si and/or Ca-O-Al bonds through the combined application of mechanical impact forces and heating. In some cases, the reaction product may comprise Ca-O-Si bonds that form during the solid-state reactions between calcium oxide and silicon dioxide. The formation of these bonds may be facilitated by the enhanced mixing and solid-state diffusion created by the mechanical grinding forces at elevated temperatures.

The calcium silicate phases formed through the mechanochemical processing may comprise tricalcium silicate, dicalcium silicate, or combinations thereof. In some cases, the calcium silicate phases may include various polymorphs and structural configurations that result from the specific processing conditions. The formation of calcium silicate phases having Ca-O-Si bonds may occur through the combined application of mechanical impact forces and heating during the mechanochemical synthesis process.

The mechanochemical approach may enable formation of multiple silicate phases that exhibit hydraulic reactivity similar to conventional cement materials. In some cases, the reaction products may contain calcium silicate phases in amounts ranging from 70% to 90% or more of the total reaction product formed by the combined mechanical and thermal treatment. The formation of these phases may occur at temperatures substantially lower than those used in conventional cement kiln processes while maintaining the structural characteristics needed for cementitious applications.

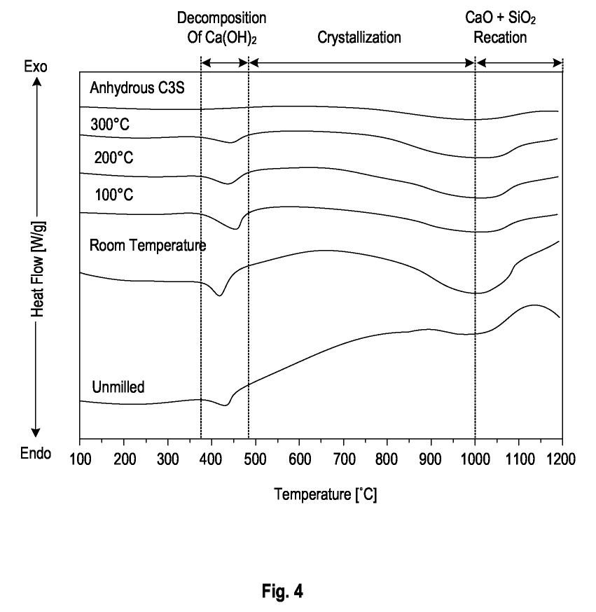

Referring to FIG. 4, differential scanning calorimetry curves may be obtained to analyze the thermal behavior of calcium oxide and silicon dioxide mixtures processed under different mechanochemical conditions. The differential scanning calorimetry curves may plot heat flow versus temperature for samples that were unmilled and samples that were milled at various temperatures including room temperature, 100°C, 200°C, and 300°C. In some cases, a reference curve for anhydrous tricalcium silicate may be included for comparison purposes.

The differential scanning calorimetry analysis may reveal distinct thermal events that occur during heating of the processed materials. The vertical axis may represent heat flow in watts per gram with exothermic reactions shown in the upward direction and endothermic reactions shown in the downward direction. The horizontal axis may represent temperature ranging from approximately 100°C to 1200°C during the thermal analysis.

The differential scanning calorimetry curves may display endothermic peaks that correspond to decomposition of calcium hydroxide phases present in the processed materials. The endothermic peaks may appear between approximately 375°C and 475°C for both the unmilled and milled samples. The calcium hydroxide may form when calcium oxide contacts water vapor in air during sample preservation and handling processes.

With continued reference to FIG. 4, the endothermic peaks corresponding to calcium hydroxide decomposition may become less pronounced for samples that were milled at higher temperatures. The reduction in endothermic peak intensity may suggest that higher milling temperatures thermodynamically favor the dehydration process during mechanochemical treatment. In some cases, the diminishing intensity of the calcium hydroxide decomposition peak may indicate that elevated temperature milling facilitates removal of hydroxide phases during processing.

The differential scanning calorimetry curves may exhibit exothermic regions that extend from approximately 475°C to 1000°C, corresponding to heat of crystallization from thermally induced crystal restructuring. In some cases, samples milled at higher temperatures may show reduced heat flow intensity in the exothermic region compared to unmilled samples or samples processed at lower temperatures. The reduction in exothermic behavior may indicate that some degree of crystallization or phase transformation has already occurred during the mechanochemical milling treatment.

The differential scanning calorimetry analysis may demonstrate that mechanochemical processing at elevated temperatures may result in partial conversion of starting materials to calcium silicate phases during the milling treatment itself. In some cases, the reduced exothermic response in samples milled at higher temperatures may provide evidence that calcium silicate formation has been initiated through the combined mechanical and thermal treatment. The thermal analysis may support the formation of nanocrystalline calcium silicate phases through the mechanochemical synthesis process.

Above 1000°C, the differential scanning calorimetry curves may show varying degrees of exothermic behavior corresponding to reactions between calcium oxide and silicon dioxide. In some cases, samples milled at higher temperatures may exhibit reduced exothermic response in this temperature region compared to unmilled samples. The decreased exothermic activity at high temperatures may indicate that some of the calcium oxide and silicon dioxide reaction has already taken place during the mechanochemical processing, resulting in partial formation of calcium silicate phases.

The thermal behavior analysis may provide evidence that the mechanochemical synthesis approach facilitates formation of calcium silicate phases at temperatures lower than those typically required for conventional cement production. In some cases, the differential scanning calorimetry results may demonstrate that the combination of mechanical grinding forces and elevated temperature processing creates conditions that promote solid-state reactions between calcium-containing and silicon-containing precursors. The thermal analysis may support the effectiveness of the mechanochemical approach for producing hydraulically reactive cement materials through integrated mechanical and thermal treatment processes.

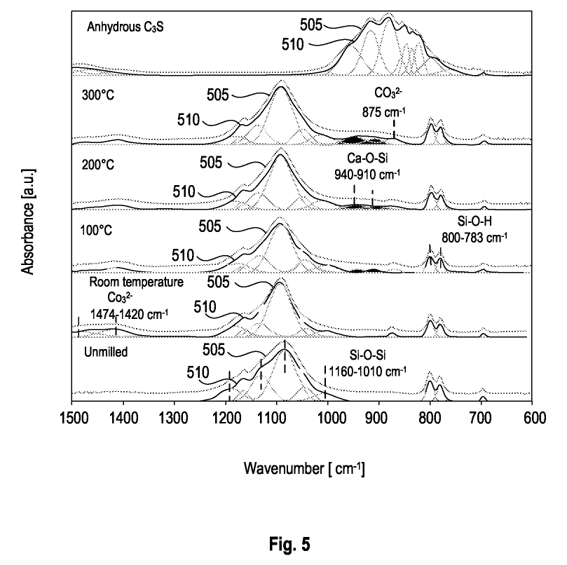

Referring to FIG. 5, ATR-FTIR spectra may be obtained to analyze the molecular structure changes and bond formation during mechanochemical processing of calcium oxide and silicon dioxide mixtures. Experimental curves 505 illustrate the experimental results, while simulated curves 510 illustrate the simulated results. The ATR-FTIR spectra may show absorbance as a function of wavenumber for CaO/SiO₂ mixtures milled at different environment temperatures and compared to a monoclinic C₃S standard. The spectra may display multiple curves representing unmilled material and samples milled at room temperature, 100°C, 200°C, and 300°C, along with an anhydrous C₃S reference curve.

The ATR-FTIR analysis may reveal characteristic absorption bands in the region from approximately 600 to 1500cm⁻¹ that correspond to various vibrational modes in the processed materials. Deconvoluted Gaussian peaks may be shown beneath the experimental spectra 505 to identify individual vibrational components. The spectra may include labeled regions indicating specific vibrational modes such as Si-O-Si bonds at 1160-1010cm⁻¹, Ca-O-Si bonds at 940-910cm⁻¹, CO₃²⁻ at 875cm⁻¹, and Si-O-H bonds at 800-783 cm⁻¹.

With continued reference to FIG. 5, the formation of Ca-O-Si bonds may be evidenced by the characteristic stretching mode band that appears at 910-940 wavenumbers. The band at 910-940cm⁻¹ may be assigned to the Ca-O-Si stretching mode of the silicate phases formed during mechanochemical processing. In some cases, this vibrational signature may grow with higher milling temperatures, indicating increased formation of calcium silicate phases as the processing temperature increases.

The ATR-FTIR spectra may demonstrate that the Ca-O-Si stretching mode band becomes more prominent in samples processed at elevated temperatures compared to unmilled samples or samples processed at room temperature. In some cases, the region corresponding to Ca-O-Si bonds may be dominant in the spectrum of the monoclinic anhydrous C₃S reference material, suggesting that calcium silicate phases are formed during the mechanochemical processing, particularly as the temperature during the milling process increases to 200°C and 300°C.

The spectroscopic analysis may show that mechanochemical processing facilitates the substitution of Ca-O-Ca ionic bonds within the calcium oxide lattice with Ca-O-Si polar covalent bonds. The formation of these Ca-O-Si bonds may occur through enhanced solid-state diffusion and mixing created by the mechanical grinding forces at elevated temperatures. The ATR-FTIR results may provide molecular-level evidence that the combined mechanical and thermal treatment promotes formation of calcium silicate phases with characteristic Ca-O-Si bonding environments.

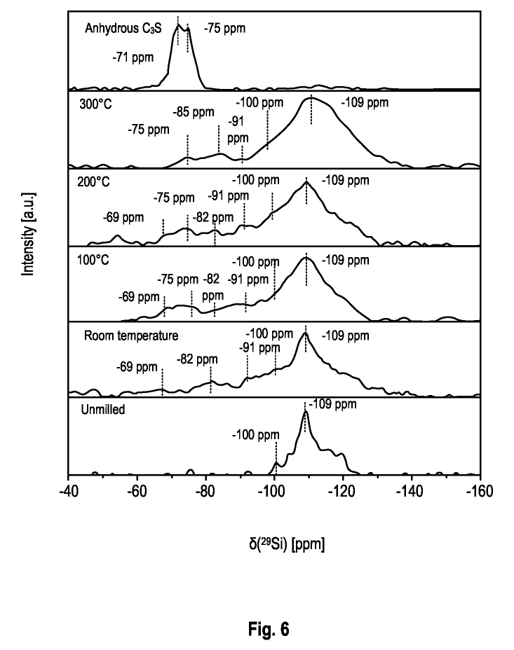

Referring to FIG. 6, silicon-29 MAS-NMR spectra may be obtained to analyze the silicon coordination environments and structural changes during mechanochemical processing. The silicon-29 MAS-NMR spectra may be collected for calcium oxide and silicon dioxide mixtures milled at different temperatures and compared to reference monoclinic anhydrous C₃S. In some cases, the NMR analysis may provide information about the local silicon environments and connectivity in the processed materials.

The silicon-29 MAS-NMR spectra may reveal distinct chemical shift regions that correspond to different silicon coordination environments. The unmilled sample may show the most abundant form of silicon atoms as Q⁴-Si, where the silicon atoms are bonded to four other tetrahedral silicon atoms via oxygen atoms. The Q⁴-Si environment may be observed with a strong resonance in the region of -100 to -120 ppm that corresponds to the presence of quartz in the starting materials.

With continued reference to FIG. 6, the milled samples may exhibit a shift toward lower coordinated silicon environments compared to the unmilled sample. In some cases, the mechanochemical processing may result in growth of resonances in the region of -90 to -100ppm corresponding to Q³-Si, -75 to -93ppm corresponding to Q²-Si, -70 to -83ppm corresponding to Q¹-Si, and -60 to -81ppm corresponding to Q⁰-Si environments. The shift from predominantly Q4 tetrahedral silicon in the unmilled sample to a mixture of Q¹, Q², and Q³ silicon environments may indicate formation of calcium silicate phases with oxygen-bridged calcium atoms.

The silicon-29 MAS-NMR analysis may show that samples milled at room temperature exhibit main resonances centered at approximately -69, -82, and -91ppm. In some cases, as the processing temperature increases, additional broad peaks may become evident and may be centered at approximately -75, -74ppm and -88ppm. The presence of these resonances may suggest that Ca-Si-O bonds typical for calcium silicate cement phases are formed during the mechanochemical processing.

The silicon-29 MAS-NMR spectra may demonstrate that the mechanochemical processing facilitates transformation of the silicon environments from the highly connected Q⁴ networks found in quartz to the lower coordination environments characteristic of calcium silicate phases. In some cases, the shift toward lower coordinated silicon environments with increasing milling temperature may provide structural evidence for the formation of calcium silicate phases through the combined mechanical and thermal treatment. The NMR analysis may confirm that the mechanochemical synthesis approach enables formation of calcium silicate structures with silicon coordination environments similar to those found in conventional cement materials.

The spectroscopic results from both ATR-FTIR and silicon-29 MAS-NMR analyses may provide complementary evidence for the formation of calcium silicate phases during mechanochemical processing. In some cases, the ATR-FTIR analysis may demonstrate formation of Ca-O-Si bonds through the characteristic stretching mode, while the NMR analysis may reveal the structural transformation of silicon environments from Q⁴ to lower coordination states. The combination of these spectroscopic techniques may confirm that the mechanochemical synthesis approach facilitates formation of calcium silicate phases with increasing milling temperature through the integrated application of mechanical grinding forces and thermal activation.

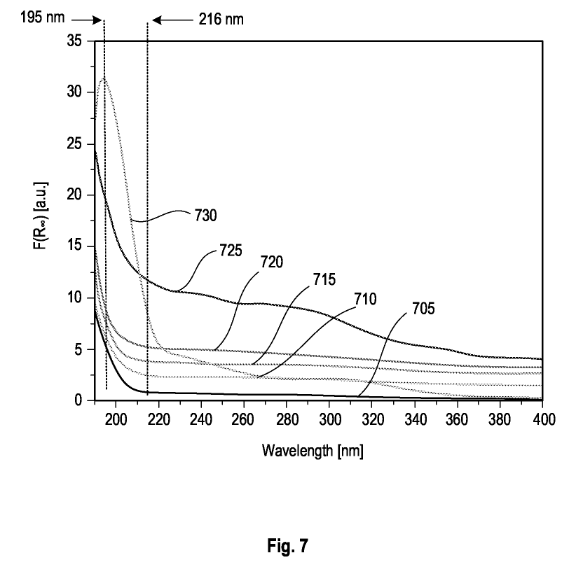

Referring to FIG. 7, UV-Vis diffuse reflectance spectroscopy may be performed to analyze the optical properties and electronic structure changes during mechanochemical processing of calcium oxide and silicon dioxide mixtures. The UV-Vis diffuse reflectance spectroscopy data may be expressed as Kubelka-Munk function versus wavelength for CaO/SiO₂ mixtures milled at different environment temperatures. In some cases, the spectroscopy analysis may provide information about the electronic transitions and bonding characteristics in the processed materials.

The UV-Vis diffuse reflectance spectroscopy may display an unmilled curve 705, a room temperature curve 710, a 100°C curve 715, a 200°C curve 720, a 300°C curve 725, and an anhydrous C3S curve 730. In some cases, the curves may show absorption characteristics in the wavelength region between 190nm and 400nm. The unmilled curve 705 may exhibit the lowest absorption intensity, while the anhydrous C3S curve 730 may show the highest absorption intensity in the lower wavelength region.

With continued reference to FIG. 7, the room temperature curve 710, the 100°C curve 715, the 200°C curve 720, and the 300°C curve 725 may demonstrate progressively increasing absorption with increasing milling temperature. In some cases, the absorption characteristics may shift toward those of the anhydrous C3S curve 730 as the mechanochemical processing temperature increases. The increased absorption of UV radiation in the lower wavelength region with increasing temperature during milling may indicate that substitution of Ca-O-Ca ionic bonds within the calcium oxide lattice with Ca-O-Si polar covalent bonds is facilitated.

The UV-Vis diffuse reflectance spectroscopy analysis may reveal characteristic band positions that provide information about the electronic structure of the processed materials. In some cases, two vertical dashed lines in the graph may mark wavelengths at 195nm and 216nm, highlighting characteristic band positions for the materials. The characteristic band position may be determined as 195nm for the monoclinic anhydrous C3S reference material.

The optical property analysis may demonstrate changes in band gap energies that correlate with the formation of calcium silicate structures during mechanochemical processing. In some cases, the characteristic band gap energies may be determined using the Tauc method for the unmilled mixture and samples milled at different temperatures. The band gap energy for the unmilled mixture may be approximately 6.17 eV, while samples milled at room temperature, 100°C, 200°C, and 300°C may show band gap energies of approximately 6.03 eV, 6.00 eV, 5.97 eV, and 5.93 eV, respectively.

The band gap energy for the anhydrous C₃S sample may be estimated at approximately 5.77 eV. In some cases, the progressive decrease in band gap energy with increasing milling temperature may indicate that the processed materials are approaching the electronic characteristics of the reference calcium silicate material. The reduction in band gap energy may correlate with the formation of calcium silicate phases through the mechanochemical synthesis process.

The absorption of UV radiation may show the excitation of electrons from bonding to non-bonding orbitals in the processed materials. In some cases, alkali earth oxides such as calcium oxide may exhibit ionic bonds between molecules, resulting in poor absorption of UV radiation and large band gaps. However, once Ca-O-Si bonds are formed during mechanochemical processing, the transition toward ionic-covalent properties of the samples may result in higher absorption of UV light and reduced band gap energies.

The UV-Vis diffuse reflectance spectroscopy results may provide optical evidence that the mechanochemical processing facilitates formation of calcium silicate phases with electronic properties similar to conventional cement materials. In some cases, the progressive changes in absorption characteristics and band gap energies with increasing milling temperature may demonstrate that the combined mechanical and thermal treatment promotes transformation of the starting materials into calcium silicate structures. The optical property analysis may complement the structural and spectroscopic characterization techniques in confirming the effectiveness of the mechanochemical synthesis approach for producing hydraulically reactive cement materials.

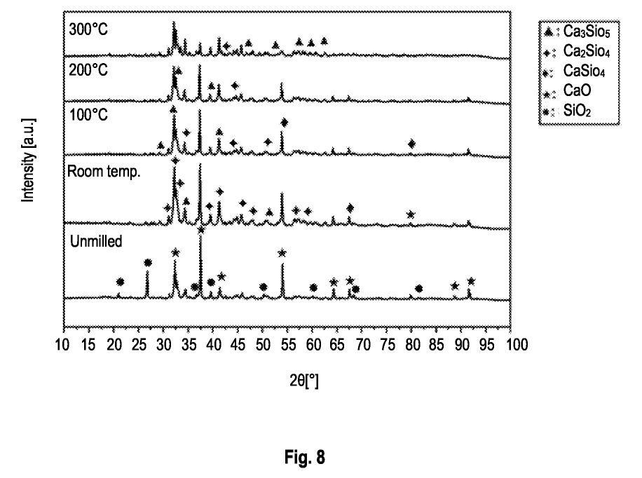

Referring to FIG. 8, X-ray diffraction patterns may be obtained for calcium oxide and silicon dioxide mixtures milled at different environment temperatures and subsequently annealed at 1000°C for 2 hours to analyze the crystallization behavior of the mechanochemically processed materials. The X-ray diffraction patterns may display intensity as a function of 2θ angle, with five vertically stacked traces corresponding to samples processed at 300°C, 200°C, 100°C, room temperature, and an unmilled sample. In some cases, the annealing treatment may facilitate crystallization of the nanocrystalline calcium silicate phases formed during the mechanochemical processing into detectable crystalline structures.

The processed material may be annealed under 200 ml/min air flow at 1000°C for 2 hours in a furnace with a temperature ramp rate of 10 K/min. In some cases, the annealing process may promote further crystallization of the mechanochemically activated materials, enabling formation of well-defined calcium silicate phases that may be readily identified through X-ray diffraction analysis. The controlled annealing conditions may provide thermal energy for completing the solid-state reactions initiated during the mechanochemical processing.

With continued reference to FIG. 8, the diffraction patterns may reveal that the unmilled sample exhibits prominent peaks corresponding to calcium oxide and silicon dioxide starting materials. In some cases, the annealed samples that were previously milled at elevated temperatures may show reduced intensities of the starting material peaks and emergence of calcium silicate phase peaks. The reduction in starting material peaks may become more pronounced at higher milling temperatures, indicating greater conversion of the precursor materials during the combined mechanochemical and annealing treatment.

The X-ray diffraction analysis may demonstrate formation of multiple calcium silicate phases including Ca₃SiO₅, Ca₂SiO₄, and CaSiO₃ in the annealed samples. In some cases, the crystalline phases present in the samples may be identified through characteristic diffraction peaks at various 2θ positions between approximately 10° and 100°. The emergence of these calcium silicate phase peaks may provide evidence that the mechanochemical processing creates reactive precursor materials that readily crystallize into cementitious phases upon annealing.

The annealing treatment may enable formation of reaction products comprising multiple silicate phases present in an amount of at least 70% of the reaction product. In some cases, the silicate phases may be present in an amount of at least 90% of the reaction product following the combined mechanochemical processing and annealing treatment. The phase content analysis may indicate a decrease in calcium oxide content from approximately 25 g per 100 g in the annealed unmilled sample to 16.5 g in the sample milled at room temperature, and further down to 5.4 g at 300°C.

The silicon dioxide content may drop to less than 1 g per 100 g when milled at temperatures of 100°C or above prior to annealing. In some cases, upon annealing at 1000°C for 2 hours, the silicate phase content may reach up to approximately 94 g per 100 g of sample when pre-milled at 300°C. The high silicate phase content may demonstrate that the mechanochemical processing creates highly reactive precursor materials that convert efficiently to calcium silicate phases during subsequent annealing.

The processed material may be pre-milled at elevated temperature and then pushed through an annealing oven at 400 K lower temperature than conventional kilns. In some cases, the annealing temperature of 1000°C may be 400 K lower than the conventional approach of a cement clinker kiln, which typically operates at temperatures up to approximately 1400°C. The integration of heating with mechanical impact during the pre-milling stage may significantly reduce the heating requirements for subsequent thermal treatment, particularly at higher temperature regimes.

The pre-mill annealing approach may demonstrate that mechanochemical processing at elevated temperatures facilitates formation of calcium silicate phases that may be completed at substantially reduced annealing temperatures compared to conventional cement production methods. In some cases, the combination of mechanochemical activation followed by moderate temperature annealing may provide an energy-efficient pathway for producing hydraulically reactive cement materials. The reduced annealing temperature requirements may offer advantages in terms of energy consumption and processing costs while maintaining the formation of calcium silicate phases present in an amount of at least 70% of a total reaction product formed by the combined mechanical and thermal treatment.

The calcium silicate phases may be present in an amount of at least 90% of the total reaction product following the integrated mechanochemical processing and annealing approach. In some cases, the high conversion efficiency achieved through the pre-mill annealing method may demonstrate the effectiveness of combining mechanical activation with controlled thermal treatment for producing cementitious materials. The ability to achieve such high silicate phase content at reduced processing temperatures may represent a significant advancement in energy-efficient cement production technologies.

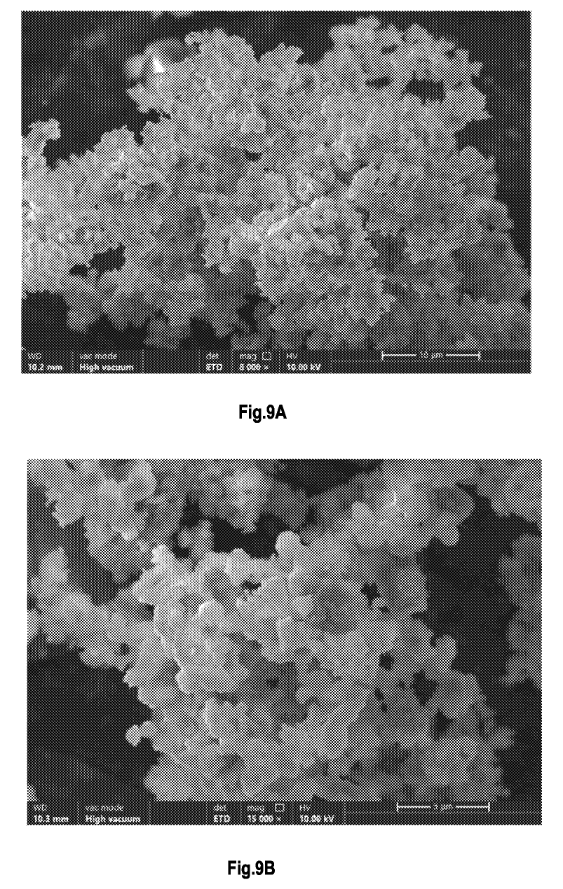

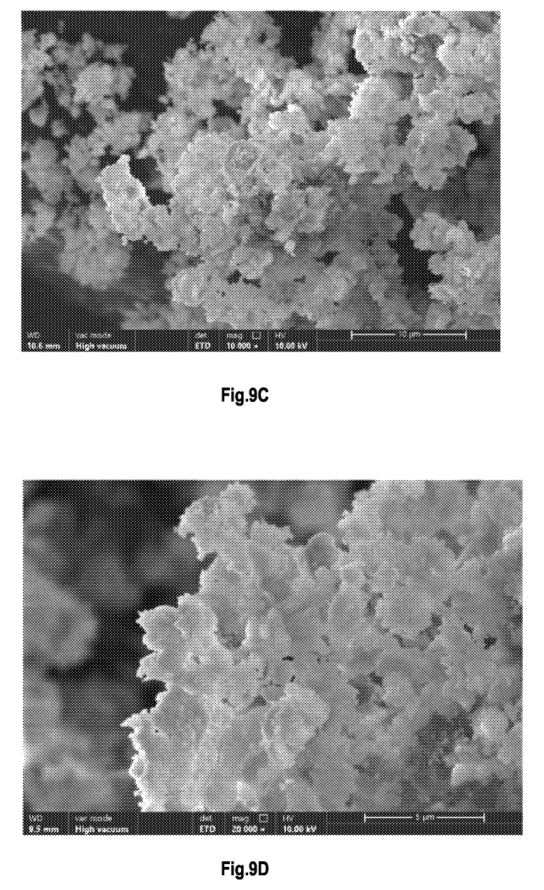

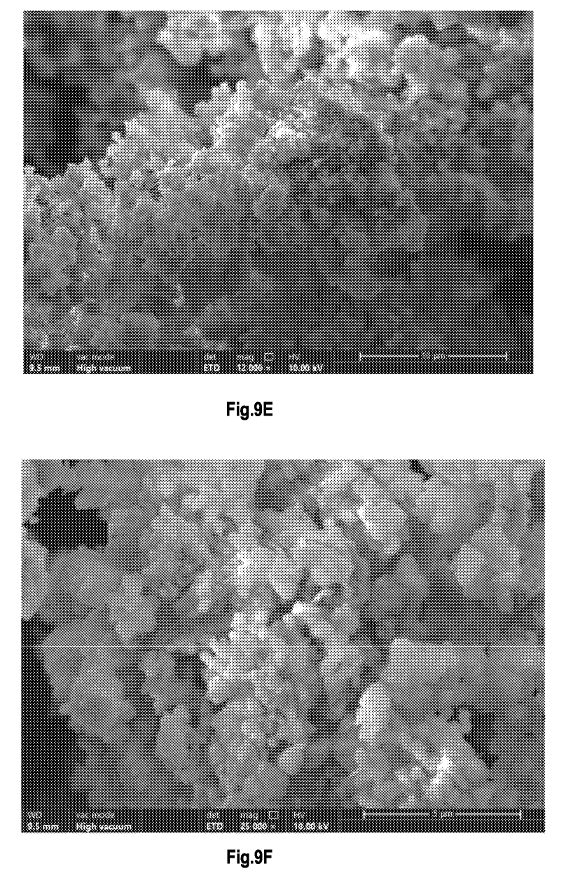

Referring to FIGS. 9A and 9B, scanning electron microscopy images may be obtained for unmilled CaO/SiO₂ mixtures to analyze the initial morphological characteristics of the starting materials. The scanning electron microscopy images may reveal larger and bulkier particles in the unmilled samples. In some cases, the unmilled materials may exhibit distinct particle boundaries and relatively coarse morphological features that reflect the original particle size distribution of the calcium oxide and silicon dioxide precursors.

The unmilled samples may display clear phase separation between the calcium oxide and silicon dioxide components, as evidenced by the distinct morphological regions visible in the scanning electron microscopy analysis. In some cases, the particle surfaces may appear relatively smooth and well-defined, indicating minimal mechanical disruption or surface activation in the starting materials. The morphological characteristics of the unmilled samples may provide a baseline for comparison with the mechanochemically processed materials.

Referring to FIGS. 9C and 9D, scanning electron microscopy images may be obtained for CaO/SiO₂ mixtures milled at room temperature to analyze the morphological changes resulting from mechanical grinding forces. The scanning electron microscopy images may illustrate both fragmentation and agglomeration of particles following the mechanochemical processing. In some cases, the particles may appear finer compared to the unmilled samples, while simultaneously tending to form large aggregates through agglomeration processes.

The mechanochemical processing at room temperature may result in significant changes to the particle morphology and size distribution compared to the unmilled materials. In some cases, the mechanical grinding forces may create fractured particle surfaces and increased surface area through fragmentation processes. The processed materials may exhibit improved homogeneity with reduced clear phase separation between the calcium oxide and silicon dioxide components compared to the unmilled samples.

With continued reference to FIGS. 9C and 9D, the room temperature milling may facilitate formation of particle aggregates that result from the combination of fragmentation and agglomeration phenomena during the mechanochemical processing. In some cases, the agglomeration behavior may be attributed to increased surface reactivity created by the mechanical activation of the particle surfaces. The morphological changes may reflect the initial stages of solid-state mixing and interaction between the calcium oxide and silicon dioxide components.

Referring to FIGS. 9E and 9F, scanning electron microscopy images may be obtained for CaO/SiO₂ mixtures milled at 100°C to analyze the morphological effects of elevated temperature mechanochemical processing. The scanning electron microscopy images may demonstrate continued fragmentation and agglomeration processes that are influenced by the thermal activation during milling. In some cases, the elevated temperature processing may enhance both the fragmentation of larger particles and the sintering or agglomeration of smaller particles.

The mechanochemical processing at 100°C may result in morphological characteristics that reflect the combined effects of mechanical grinding forces and thermal activation. In some cases, the particle surfaces may exhibit increased roughness and reactive sites compared to samples processed at room temperature. The elevated temperature processing may facilitate enhanced particle-particle interactions that contribute to both fragmentation and agglomeration phenomena.

The processed material may exhibit fragmentation and agglomeration during milling, with modal particle size increasing 4-5 times compared to the starting materials. In some cases, the mechanochemical processing may result in a complex particle size distribution that reflects the competing effects of particle breakage through mechanical forces and particle growth through agglomeration processes. The increase in modal particle size may be attributed to sintering processes that occur during the elevated temperature milling operations.

The particle size distribution analysis may reveal significant changes in the size characteristics of the processed materials compared to the unmilled samples. In some cases, the processed material may show a shift from unimodal distribution with modal diameter of approximately 0.5 micrometers to multi-modal distribution with modal diameters of 0.12, 10.93, 8.62, and 4.23 micrometers when milled at different temperatures. The shift to multi-modal distribution may indicate that different particle populations are created through the various fragmentation and agglomeration mechanisms active during mechanochemical processing.

The multi-modal particle size distribution may reflect the complex nature of the mechanochemical processing, where simultaneous fragmentation and agglomeration processes create particle populations with different size characteristics. In some cases, the smallest modal diameter of 0.12 micrometers may correspond to fine particles created through intensive fragmentation, while the larger modal diameters may result from agglomeration and sintering processes. The intermediate modal diameters of 8.62 and 4.23 micrometers may represent particle populations formed through moderate degrees of fragmentation or limited agglomeration.

The rise in oversized particles during the milling process may be attributed to sintering processes that occur under the elevated temperature conditions. In some cases, the thermal activation during mechanochemical processing may facilitate particle bonding and growth through solid-state sintering mechanisms. The formation of larger particle aggregates may influence the overall reactivity and processing characteristics of the mechanochemically synthesized materials.

The change in particle size during milling may have effects on the overall post-processing of the material and the reactivity of the resulting cement products. In some cases, smaller particles and higher specific surface area may correlate with higher reactivity and overall strength of the cement materials. The particle size distribution characteristics may influence the hydraulic reactivity and performance properties of the mechanochemically synthesized calcium silicate phases.

The morphological and particle size analysis may demonstrate that mechanochemical processing creates complex microstructural changes that involve both particle breakdown and particle growth mechanisms. In some cases, the balance between fragmentation and agglomeration processes may be influenced by the processing temperature, mechanical energy input, and duration of treatment. The resulting particle size distribution and morphological characteristics may affect the subsequent processing requirements and application properties of the mechanochemically synthesized cement materials.

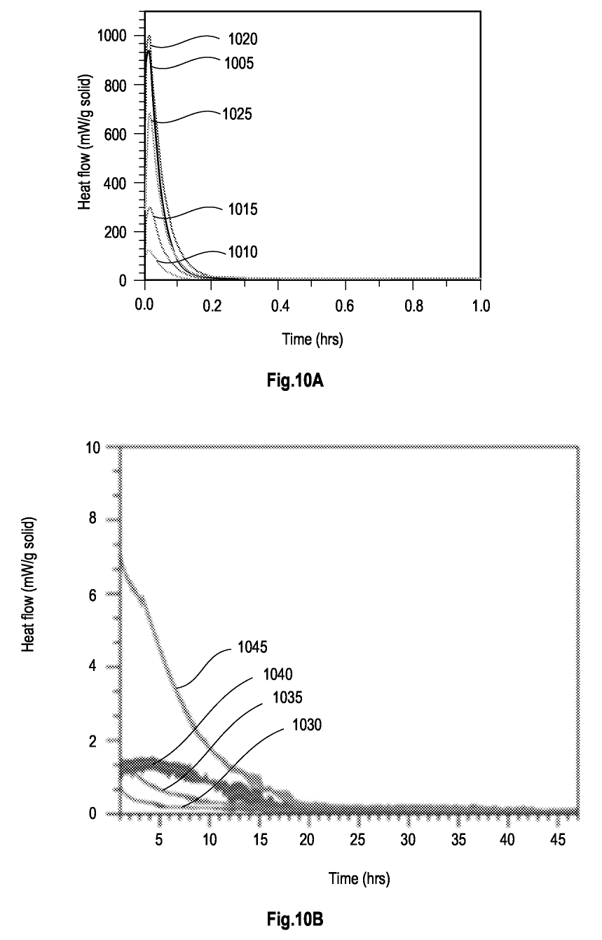

Referring to FIGS. 10A and 10B, heat flow calorimetry may be performed to assess the cementitious activity and hydration behavior of mechanically activated samples mixed with water. The heat flow calorimetry data may display heat flow versus time during hydration of the processed materials to evaluate their hydraulic reactivity. In some cases, the calorimetry analysis may provide evidence of cement-like behavior in the mechanochemically synthesized materials through characteristic heat evolution patterns during contact with water.

In FIG. 10A, which may cover the first hour of hydration, an unmilled curve 1005, a room temperature curve 1010, a 100°C curve 1015, a 200°C curve 1020, and a 300°C curve 1025 may be displayed. The curves may show initial heat release peaks that correspond to the reaction of calcium oxide with water and formation of calcium hydroxide. In some cases, the first peak at the initial minutes of contact with water may be attributed to the exothermic reaction of residual calcium oxide with water in the processed materials.

With continued reference to FIGS. 10A and 10B, FIG. 10B may extend the analysis up to 47 hours of hydration and may display a room temperature curve 1030, a 100°C curve 1035, a 200°C curve 1040, and a 300°C curve 1045. The extended hydration analysis may reveal secondary heat evolution between approximately 2 to 10 hours that indicates hydration of calcium silicates formed during the mechanochemical processing. In some cases, the heat flow may increase progressively from the room temperature curve 1030 through the 100°C curve 1035 and the 200°C curve 1040 to the 300°C curve 1045.

The secondary heat evolution observed in the time span from 2 to 10 hours may represent a large hump and increase in the heat of hydration for all mechanochemically processed mixtures. In some cases, this secondary heat release may not be observed for the unmilled sample, suggesting that the mechanochemical processing creates hydraulically reactive phases that exhibit cement-like hydration behavior. The presence of the secondary hydration peak may indicate formation of calcium silicate phases that react with water to produce cementitious hydration products.

The heat flow calorimetry results may demonstrate that mechanochemically activated samples exhibit hydraulic activity similar to conventional cementitious materials. In some cases, the hydration reaction and cement-like behavior may be more enhanced in samples subjected to milling at 300°C compared to samples processed at lower temperatures. The progressive increase in hydration activity with increasing mechanochemical processing temperature may correlate with the enhanced formation of calcium silicate phases during the elevated temperature milling operations.

The processed material may be retrieved after reaction and subjected to cleaning procedures to prepare samples for hydration studies. In some cases, the processed material may be cleaned with silica-alumina powder before being sonicated for 30 minutes and dried in a 103°C convection oven. The cleaning and preparation procedures may remove surface contaminants and ensure consistent sample conditions for subsequent hydration analysis.

The processed material may be mixed with water at a water-to-solid ratio of 1 for hydration studies conducted using isothermal calorimetry. In some cases, a relatively small amount of the dry powder may be mixed with water and placed in small ampules in the calorimeter for measurement at 23°C for 47 hours. The standardized water-to-solid ratio may enable consistent comparison of hydration behavior across different mechanochemically processed samples.

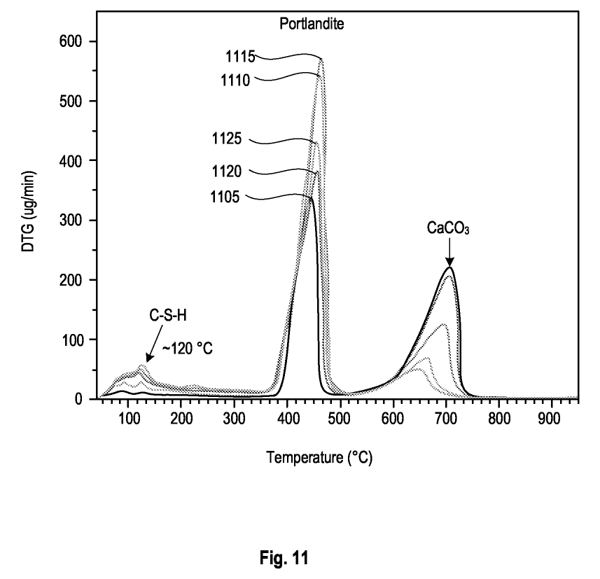

Referring to FIG. 11, thermogravimetric analysis may be performed on hydrated samples to identify the hydration products formed during the cement-like reactions of the mechanochemically processed materials. The thermogravimetric analysis may display differential thermal gravimetry curves for CaO/SiO₂ mixtures processed under different conditions at 47 hours after mixing with water. In some cases, the analysis may be performed using inert nitrogen gas flow at 100 ml/min with a controlled heating profile from 40°C to 1000°C.

The thermogravimetric analysis may display an unmilled curve 1105, a room temperature curve 1110, a 100°C curve 1115, a 200°C curve 1120, and a 300°C curve 1125 representing samples processed at different mechanochemical conditions. In some cases, each curve may show distinct thermal decomposition peaks that correspond to different hydration products formed during the cement-like reactions. The thermal analysis may provide identification of specific hydration phases that contribute to the cementitious properties of the mechanochemically synthesized materials.

With continued reference to FIG. 11, the thermogravimetric analysis may reveal formation of calcium silicate hydrate as the main hydration product in the mechanochemically processed samples. The calcium silicate hydrate may be identified through a broad signal in the temperature range from 80°C to 130°C, with a more evident peak centered at approximately 120°C. In some cases, the calcium silicate hydrate phase may be more abundant in samples subjected to milling at 300°C compared to samples processed at lower temperatures.

The calcium silicate hydrate may exhibit water loss in the temperature range of 50°C to 600°C due to dehydration of interlayer water and dehydroxylation reactions. In some cases, the formation of calcium silicate hydrate as the predominant hydration product may be similar to the main hydration product found in Portland cement systems. The identification of calcium silicate hydrate may provide evidence that the mechanochemically synthesized materials exhibit hydraulic reactivity comparable to conventional cementitious materials.

The thermogravimetric analysis may also identify formation of calcium hydroxide and calcium carbonate phases in the hydrated samples. In some cases, the calcium hydroxide may form through interaction of calcium oxide with water, or may be formed from hydraulic reaction of calcium silicates during the hydration process. The calcium carbonate may form through carbonation reactions with carbon dioxide in air during sample handling and storage.

The thermal analysis may demonstrate that mechanochemically processed samples exhibit formation of hydration products that are characteristic of cementitious materials. In some cases, the identification of both calcium silicate hydrate and calcium hydroxide as main products of the hydration process may suggest that hydraulic reactions of the nanocrystalline calcium silicate phases occur during contact with water. The formation of these hydration products may indicate that the mechanochemically synthesized materials have potential to act as hydraulically reactive cement materials.

The hydration studies may provide evidence that the mechanochemical synthesis approach produces materials with cementitious properties through formation of calcium silicate phases that react with water to form characteristic hydration products. In some cases, the combination of heat flow calorimetry and thermogravimetric analysis may demonstrate that the mechanochemically processed materials exhibit hydraulic activity and hydration behavior similar to conventional cement materials. The hydration reactivity studies may support the effectiveness of the mechanochemical approach for producing hydraulically reactive cement materials through integrated mechanical and thermal processing at reduced temperatures compared to conventional kiln operations.

The mechanochemical synthesis methods may utilize sequential processing operations to enhance the reactivity and formation of hydraulically reactive cement materials. In some cases, the processed material may undergo sequential reactions where different ingredients are milled separately and then brought together for final milling. The sequential processing approach may provide enhanced control over the activation and reactivity of individual components before combining them for the mechanochemical synthesis reactions.

The sequential milling approach may involve separate mechanical treatment of calcium-containing and silicon-containing precursor materials prior to combining them for final processing. In some cases, the calcium oxide may be subjected to individual mechanical activation in a first milling step to create reactive surface sites and enhanced surface area. The silicon dioxide may be separately processed through mechanical grinding to generate reactive surface groups and activated silica structures that facilitate subsequent solid-state reactions.

The separate milling of individual components may create more reactive surface groups on the calcium oxide and silicon dioxide precursors compared to direct co-milling approaches. In some cases, the mechanical activation of silicon dioxide may result in formation of silanol groups and other reactive surface species that enhance the reactivity toward calcium-containing phases. The individual processing of calcium oxide may generate surface defects and reactive sites that promote solid-state diffusion and chemical interaction during subsequent combined processing. In some cases, depending on the relative hardness of the starting minerals, the new phases can form either on the limestone or the silica source.

The sequential processing operations may involve controlled atmospheres during the separate milling steps to optimize the surface activation of individual components. In some cases, the silicon dioxide may be milled in the presence of water vapor to create reactive silanol surface groups that facilitate bonding with calcium-containing phases. The calcium oxide may be processed under controlled atmospheric conditions to prevent unwanted carbonation or hydroxylation while maintaining surface reactivity for subsequent mechanochemical reactions.

Following the separate activation of individual components, the mechanochemically activated calcium oxide and silicon dioxide may be combined for final processing under elevated temperature conditions. In some cases, the pre-activated precursors may exhibit enhanced reactivity during the combined mechanochemical treatment compared to materials that have not undergone separate activation steps. The sequential approach may enable formation of calcium silicate phases at reduced processing times or temperatures due to the enhanced reactivity of the individually processed components.

The sequential milling operations may utilize different processing parameters for the individual component activation steps compared to the final combined processing step. In some cases, the separate milling of calcium oxide and silicon dioxide may be conducted at different temperatures, frequencies, or durations to optimize the surface activation of each component. The final combined processing step may then utilize processing conditions that are specifically selected to promote solid-state reactions between the pre-activated precursors.

The sequential processing approach may provide advantages in terms of controlling the stoichiometry and mixing characteristics of the final mechanochemical reactions. In some cases, the separate processing of individual components may enable precise control over the activation level and surface characteristics of each precursor before combining them in desired stoichiometric ratios. The enhanced mixing and reactivity achieved through sequential processing may facilitate formation of more uniform calcium silicate phases with improved hydraulic properties.

The sequential milling method may be particularly beneficial for processing precursor materials with different mechanical properties or activation requirements. In some cases, the calcium oxide and silicon dioxide components may require different mechanical energy inputs or processing conditions to achieve optimal surface activation. The sequential approach may enable customized processing conditions for each component while maintaining the benefits of combined mechanochemical synthesis for the final calcium silicate formation reactions.

The pre-activated precursor materials produced through sequential processing operations may exhibit enhanced solid-state diffusion characteristics during the final combined mechanochemical treatment. In some cases, the reactive surface groups created during separate milling may facilitate more rapid formation of Ca-O-Si bonds and calcium silicate phases compared to conventional co-milling approaches. The sequential processing method may represent an advanced approach for optimizing the mechanochemical synthesis of hydraulically reactive cement materials through controlled activation of individual components.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A method of making hydraulic cement, comprising:
providing a vessel having a chamber;
placing a first reagent comprising calcium oxide and a second reagent comprising silicon dioxide in the chamber; and
mechanochemically reacting the first and second reagents by simultaneously applying mechanical grinding forces and heating the chamber to a temperature above room temperature to form a reaction product comprising nanocrystalline calcium silicate phases.

2. The method of claim 1, wherein the first and second reagents are present in the chamber at a stoichiometric ratio of calcium to silicon of about 1:1 to about 5:1.

3. The method of claim 1, wherein the chamber contains one or more grinding elements.

4. The method of claim 3, wherein the grinding elements comprise grinding balls.

5. The method of claim 4, wherein applying the mechanical grinding forces comprises operating the vessel to generate impact velocities of 1-20 m/s.

6. The method of claim 1, wherein mechanochemically reacting the first and second reagents comprises heating the chamber to a temperature of 100°C to 1000°C.

7. The method of claim 1, wherein the vessel further comprises a thermal controller configured to regulate an internal temperature of the chamber during reacting.

8. The method of claim 1, wherein the reaction product comprises Ca-O-Si and/or Ca-O-Al bonds.

9. The method of claim 1, wherein the reaction product comprises multiple silicate phases present in an amount of at least 70% of the reaction product.

10. The method of claim 9, wherein the silicate phases are present in an amount of at least 90% of the reaction product.

11. A method of synthesizing hydraulically reactive calcium silicate minerals, comprising:
loading calcium oxide and silicon dioxide into a milling vessel containing grinding elements;
sealing the milling vessel;
applying mechanical impact forces with the grinding elements to the calcium oxide and silicon dioxide;
simultaneously heating the milling vessel to an elevated temperature above room temperature during the mechanical impact; and
forming calcium silicate phases having Ca-O-Si and/or Ca-O-Al bonds through the combined application of mechanical impact forces and heating.

12. The method of claim 11, wherein the calcium oxide and silicon dioxide are present at a stoichiometric ratio of calcium to silicon of 1:1 to 5:1.

13. The method of claim 12, wherein the stoichiometric ratio of calcium to silicon is about 3:1.

14. The method of claim 11, wherein applying mechanical impact forces with the grinding elements to the calcium oxide and silicon dioxide comprises operating the milling vessel to generate impact velocities of 1-20 m/s.

15. The method of claim 11, wherein the mechanical impact forces are applied for a duration of 5 minutes to 2 days.

16. The method of claim 11, wherein the milling vessel is heated to an elevated temperature of 100°C to 1000°C.

17. The method of claim 11, wherein the milling vessel further comprises a thermal controller configured to regulate the elevated temperature during the mechanical impact.

18. The method of claim 11, wherein the calcium silicate phases comprise tricalcium silicate, dicalcium silicate, or combinations thereof.

19. The method of claim 11, wherein the calcium silicate phases are present in an amount of at least 70% of a total reaction product formed by the combined mechanical and thermal treatment.

20. The method of claim 19, wherein the calcium silicate phases are present in an amount of at least 90% of the total reaction product.
